(19) United States
(12) Patent Application Publication
(10) Pub. No.: US 2006/0198279 A1
(43) Pub. Date: Sep. 7, 2006

(54) Optical pickup apparatus

(75) Inventors: Tatsuji Kurogama, Hachioji-shi (JP); Katsuya Yagi, Hino-shi (JP); Kiyono Ikenaka, Hino-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/418,998

(22) Filed: May 5, 2006

Related U.S. Application Data
(63) Continuation-in-part of application No. 10/972,970, filed on Oct. 25, 2004.

(30) Foreign Application Priority Data
Oct. 27, 2003 (JP) JP2003-366377
May 11, 2005 (JP) JP2005-138895

(51) Int. Cl. G11B 7/135

(52) U.S. Cl. 369/112.24

(57) ABSTRACT

An optical pickup apparatus includes: a first light source; a second light source; a third light source; an objective lens; a coupling lens; a light flux splitter; and a light-receiving element. The coupling lens is formed of two or more lenses in two or more groups, and at least one group of the lenses forming the coupling lens is arranged movably along an optical axis of the coupling lens. The each of the first to third light source and a light-receiving portion in the light-receiving element is optically conjugate each other through an information recording surface of the information recording medium when at least one group of the lenses in the coupling lens is positioned at the predefined position.

This application is a continuation-in-part application of U.S. patent application Ser. No. 10/972,970, filed on Oct. 25, 2004 and is based on Japanese Patent Application No. 2003-138895 filed on May 11, 2005, in Japanese Patent Office, the entire content of which is hereby incorporated by reference.

### FIELD OF THE INVENTION

The present invention relates to an optical pickup apparatus, and in particular, to an optical pickup apparatus capable of conducting recording and/or reproducing of information properly for an optical information recording medium.

### BACKGROUND OF THE INVENTION

In recent years, there have been advanced rapidly research and development of a high density optical disc system that can conduct recording and/or reproducing of information by using a violet semiconductor laser having a wavelength of about 400 nm. As an example, in the case of an optical disc that conducts recording and/or reproducing of information under the specifications of NA 0.85 and a light source wavelength of 405 nm, namely, in the case of the so-called Blu-ray Disc (BD), information of 20-30 GB can be recorded on one surface for an optical disc having a diameter of 12 cm that is the same as that of DVD (NA 0.6, light source wavelength 650 nm and memory capacity 4.7 GB). In the case of an optical disc that conducts recording and/or reproducing of information under the specifications of NA 0.65 and a light source wavelength of 405 nm, namely, in the case of the so-called HD DVD, information of 15-20 GB can be recorded on one surface for an optical disc having a diameter of 12 cm. Hereinafter, the optical disc mentioned above is called “a high density DVD” in the present specification.

Incidentally, when an optical pickup apparatus conducts recording and/or reproducing of information properly only for the high density DVD, a value of the optical pickup apparatus as a product is not sufficient. When considering the present fact where DVD and CD on which various types of information are recorded are on the market, only ability to conduct recording and/or reproducing of information properly for the high density DVD is not sufficient. Namely, the ability to equally conduct recording and/or reproducing of information properly also for conventional DVD or CD owned by a user, for example, enhances a value of a product as an optical pickup apparatus of a compatible type. With the background of this kind, an optical system used for the optical pickup apparatus of a compatible type is required naturally to be at low cost and to be simple in structure, and further is required to obtain an excellent spot for conducting recording and/or reproducing of information properly for high density DVD and even for conventional DVD and CD. Further, though an optical pickup apparatus capable of conducting recording and/or reproducing of information for DVD and CD on a compatible basis is in practical use, the existing optical pickup apparatus is required to be smaller in size, thinner in thickness and lower in cost.

Each of Japanese Patent Applications Publication Open to Public Inspection Nos. H10-199021 and 2002-236253 discloses an optical pickup apparatus wherein compact structure is realized by the use of a common objective lens and a common photodetector, and recording and/or reproducing of information can be conducted for two types of optical discs each being different each other, by using a movable coupling lens.

However, the optical pickup apparatus disclosed in each of Japanese Patent Applications Publication Open to Public Inspection Nos. H10-199021 and 2002-236253 conducts recording and/or reproducing for two types of optical discs each being different from another, and when conducting recording and/or reproducing of information for at lease three types of optical discs, further devices are needed.

### SUMMARY OF THE INVENTION

The present invention is achieved in view of the above problems in the conventional technology, and provides an optical pickup apparatus capable of conducting recording and/or reproducing of information on a compatible basis for at least three types of optical information recording media, by using a common objective lens and a common photodetector.

An optical pickup apparatus according to the present invention includes a first light source, a second light source, a third light source, an objective lens, a coupling lens, a light flux splitter, and a light-receiving element. The objective lens is used for converging a light flux from each of the first to third light sources on an information recording surface of a corresponding optical information recording medium. The coupling lens is arranged in a common optical path of light fluxes emitted by the first to third light sources and in an optical path between the objective lens and each of the first to third light sources. The coupling lens is formed of two or more lenses in two or more groups, and at least one group of the lenses forming the coupling lens is arranged movably along an optical axis of the coupling lens. The light flux splitter is used for separating a light flux reflected by the information recording surface of the optical information recording medium from a light flux emitted from each of the first to third light sources. The light-receiving element is used for receiving a light flux reflected by the information recording surface of the optical information recording medium and separated by the light flux splitter. The light-receiving element includes a light-receiving portion for receiving a light flux emitted from each of the first to third light sources, and the light-receiving portion is packaged in one light-receiving element. When the at least one group of the coupling lens is moved to the predefined position, each of the first-third light sources and a light-receiving portion in the light-receiving element are optically conjugate each other through the information recording surface of the corresponding information recording medium and the light flux emitted by the light source is converged on an information recording surface of the corresponding information recording medium.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a schematic diagram of an optical pickup apparatus as a comparative example in which three light sources each being different from others in terms of a wavelength are arranged at positions such that a light flux entering each objective lens forms a prescribed divergent angle;

Each of FIGS. 2(a)-2(c) is a diagram showing positional relationship between each light source and each light-receiving element in the case of conducting recording and/or reproducing of information for each disc;

FIG. 3 is a perspective view showing an example of two-laser 1-packaged laser device;

FIG. 4 is a top surface diagram showing schematically the structure of an optical pickup apparatus relating to the first embodiment;

FIG. 5 is a diagram wherein the structure shown in FIG. 4 is viewed in the direction of arrow V;

FIG. 6 is a perspective view of optical system unit CU housing therein coupling lens COL and its drive unit integrally;

FIG. 7 is a perspective view showing layer-built piezoelectric actuator PZ having a structure in which plural piezoelectric ceramics PE are laminated and each of electrodes C is connected between the piezoelectric ceramics PE in parallel;

Each of FIGS. 8(a) and 8(b) is a diagram showing a waveform of a voltage pulse impressed on the piezoelectric actuator PZ;

FIG. 9 is a diagram showing schematically the structure of an optical pickup apparatus relating to the second embodiment;

FIG. 10 is a diagram showing schematically the structure of an optical pickup apparatus relating to the third embodiment;

FIG. 11 is a diagram showing schematically the structure of an optical pickup apparatus relating to the fourth embodiment;

Each of FIGS. 12(a)-12(c) is a diagram showing the relationship between a position of a coupling lens and a divergent angle of a light flux emerging from the coupling lens, and FIG. 12(a) shows that the coupling lens is at the first position and the divergent angle at that time is θ1, FIG. 12(b) shows that the coupling lens is at the second position and the divergent angle at that time is θ2, and FIG. 12(c) shows that the coupling lens is at the third position and the divergent angle at that time is θ3;

FIG. 13 is a diagram showing an example of a spot of the light flux reflected by the information recording surface of the optical disk formed on the light-receiving element;

FIG. 14 is a diagram showing an example of a spot of the light flux reflected by the information recording surface of the optical disk formed on the light-receiving element; and

FIGS. 15(a) and 15(b) are a front views of the four-quadrant light-receiving portion and a circuit diagram for obtaining focus error signal from the four-quadrant light-receiving portion by the aspherical aberration method.

### DETAILED DESCRIPTION OF THE INVENTION

A preferred embodiment of the invention will be explained as follows.

Item 1 is an optical pickup apparatus including: a first light source for emitting a light flux with a wavelength λ1; a second light source for emitting a light flux with a wavelength λ2 (λ1<λ2); a third light source for emitting a light flux with a wavelength λ3 (λ2<λ3); and an objective lens for converging a light flux from each of the first to third light sources on an information recording surface of a corresponding optical information recording medium. The optical pickup apparatus further includes a coupling lens arranged in a common optical path of the light fluxes emitted by the first to third light sources and in an optical path between the objective lens and each of the first to third light sources. The optical pickup apparatus further includes a light flux splitter for separating a light flux reflected by the information recording surface of the optical information recording medium from a light flux emitted from each of the first to third light sources. The optical pickup apparatus further includes a light-receiving element for receiving a light flux reflected by the information recording surface of the optical information recording medium and separated by the light flux splitter. The coupling lens is formed of two or more lenses in two or more groups, and at least one group of the lenses forming the coupling lens is arranged movably along an optical axis of the coupling lens. The light-receiving element comprises a light-receiving portion for receiving the light flux emitted from the first light sources, the light flux emitted from the second light sources, and the light flux emitted from the third light sources, and the light-receiving portion is packaged in one light-receiving element. The coupling lens with the at least one group moved to a first position provides a first divergent angle (θ1) to the light flux emitted by the first light source, the light flux provided the first divergent angle by the coupling lens enters into the objective lens, and the objective lens converges the entering light flux on an information recording surface of a first information recording medium with a recording density ρ1 for information recording and/or reproducing. The coupling lens with the at least one group moved to a second position provides a second divergent angle (θ2) to the light flux emitted by the second light source, the light flux provided the second divergent angle by the coupling lens enters into the objective lens, and the objective lens converges the entering light flux on an information recording surface of a second information recording medium with a recording density ρ2 (ρ1>ρ2) for information recording and/or reproducing. The coupling lens with the at least one group moved to a third position provides a third divergent angle (θ3) to the light flux emitted by the third light source, the light flux provided the third divergent angle by the coupling lens enters into the objective lens, and the objective lens converges the entering light flux on an information recording surface of a third information recording medium with a recording density ρ3 (ρ2>ρ3) for information recording and/or reproducing. The first light source and the light-receiving portion in the light-receiving element are optically conjugate each other through the information recording surface of the first information recording medium when the at least one group of the coupling lens is positioned at the first position. The second light source and the light-receiving portion in the light-receiving element are optically conjugate each other through the information recording surface of the second information recording medium when the at least one group of the coupling lens is positioned at the second position. The third light source and the light-receiving portion in the light-receiving element are optically conjugate each other through the information recording surface of the third information recording medium when the at least one group of the coupling lens is positioned at the third position.

Item 2 is the optical pickup apparatus described in Item 1 in which the wavelength λ1 is in a range of 390 to 420 nm, the wavelength λ2 is in a range of 630 to 670 nm, and the wavelength λ3 is in a range of 760 to 800 nm.

Item 3 is the optical pickup apparatus described in Item 1 or 2 in which each of the light flux emitted by the first light source and reflected by the information recording surface of the first optical information recording medium; the light flux emitted by the second light source and reflected by the information recording surface of the second optical information recording medium; and the light flux emitted by the third light source and reflected by the information recording surface of the third optical information recording medium passes through a common optical element and is received by the light-receiving portion of the light-receiving element.

Item 4 is the optical pickup apparatus described in any one of Items 1-3 in which at least two groups of the lenses in the coupling lens are arranged so that a distance of an air space between the at least two groups is variable along an optical axis.

Item 5 is the optical pickup apparatus described in any one of Items 1-4 in which one group of the lenses in the coupling lens is arranged movably along the optical axis and the other is arranged stably.

In the present specification, “a divergent angle” is an angle formed between an outermost beam and an optical axis of a light flux contributing to forming of a converged spot, when an optical axis of the objective lens is aligned with an optical axis of the optical pickup apparatus. Further, it includes an occasion where an angle of emergence is zero or negative, namely, an occasion where at least one light flux enters the objective lens as an infinite parallel light flux or a convergent light flux.

For conducting recording and/or reproducing of information for at least three types of optical information recording media (which are called optical disks) by using a common objective lens and a common photodetector, it is preferable to arrange three light sources, a focal point of the objective lens and, a light-receiving portion of a light-receiving element representing an photodetector to be in a positional relationship where all of them are optically conjugate. The reason for the forgoing will be explained below.

For obtaining excellent optical spot on an information recording surface of an optical disc for each of three wavelengths, spherical aberration caused by a wavelength difference and by a thickness difference of protective substrates of optical discs needs to be corrected. For example, in the conventional optical pickup apparatus capable of conducting recording and/or reproducing of information on a compatible basis for DVD and CD, when its spherical aberration is corrected by an optical element other than the objective lens, or by the whole of the image pickup apparatus, it is preferable that a divergent angle (or a convergent angle or a parallelism) of a light flux that enters the objective lens is made to be a prescribed value respectively. An example of the foregoing will be explained as follows.

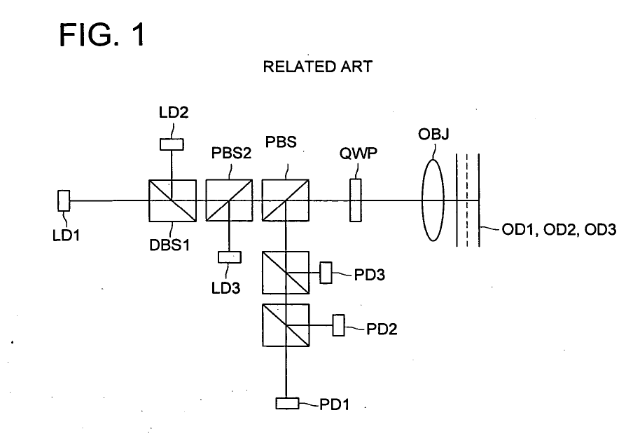

FIG. 1 is a schematic diagram of an optical pickup apparatus as a comparative example wherein three light sources each being different from others in terms of a wavelength are arranged at positions where a light flux entering each objective lens forms a prescribed divergent angle. Each of FIGS. 2(a)-2(c) is a diagram showing positional relationship between each light source and each light-receiving element in the case of conducting recording and/or reproducing of information for each disc.

For example, by assuring a distance from light source LD1 to objective lens OBJ to be long for light source LD1 having a short wavelength (FIG. 2(c)), by assuring a distance from light source LD3 to objective lens OBJ to be short for light source LD3 having a long wavelength (FIG. 2(a)), and by assuring a distance from light source LD2 to objective lens OBJ to be medium between those mentioned above for light source LD2 having a medium wavelength (FIG. 2(b)), it is possible to form properly a focused spot to be light-converged on an information recording surface of the optical disc by the common objective lens.

In this case, however, a divergent angle of a light flux entering objective lens OBJ varies basically depending on three light fluxes each being different from others in terms of a wavelength, and therefore, an optical path length from each of three light sources LD1-LD3 to objective lens OBJ is not the same as others. As a result, a light flux having its own wavelength that is focused on an information recording surface of an optical disc is converged on the point that is different from others in terms of an optical path length from the objective lens OBJ, after being reflected on the aforesaid information recording surface (FIGS. 2(a)-2(c)). Therefore, if it is attempted to receive these light fluxes for the purpose of obtaining optical information recorded on the information recording surface, three light-receiving elements are needed as shown in FIG. 1, which makes it difficult to realize a compact and low cost optical pickup apparatus. On the other hand, if it is attempted to use a common light-receiving element for realizing a compact and low cost optical pickup apparatus, an optical path length from an objective lens to a light-receiving element is required to be changed for each light flux, by using a dichroic prism having wavelength-selectivity because respective light fluxes are received by a common light-receiving element, which causes a complex structure and prevents downsizing of the apparatus that is the intended objective.

In the aforesaid Japanese Patent Applications Publication Open to Public Inspection Nos. H10-199021 and 2002-236253, the coupling lenses are all fixed or totally movable, which is different from the present invention in terms of effects. In that connection, an explanation will be given below. First, three light fluxes each having a different wavelength are assumed to be a violet light, a red light and an infrared light. In an optical pickup apparatus in which the coupling lens is fixed, if it is possible to make the emergence angle to be different despite the same incidence angle for three different wavelengths by providing the coupling lens with a diffractive function, it is possible to conduct recording and/or reproducing of information on a compatible basis for respective optical discs. However, in this case, a degree of freedom for design of an objective lens or a coupling lens is extremely restricted, because divergent angles for three wavelengths need to be set to prescribed values for corresponding to three different wavelengths, resulting in an optical system having low diffraction efficiency for light of specific wavelength, for example, which is a negative effect.

In particular, a diffractive structure is a structure providing a phase difference by forming, on an optical surface, a fine structure including steps corresponding to a wavelength of a light flux to which a diffraction effect is to be given. However, when an optical element that forms a diffractive structure is made of a material having ordinary dispersion (νd>30), an infrared light having passed through the fine structure sometimes agrees with a violet light in terms of a phase even when a different phase difference is given by the fine structure steps, because the wavelength of the infrared light (760 nm-800 nm) is a multiple number of that of the violet light (390 nm-430 nm), and, there is a fear that it becomes difficult to make a divergence degree of a light flux to be different based on a wavelength difference, thus, a degree of freedom for design is greatly restricted, for obtaining sufficient diffraction efficiency. Therefore, it becomes difficult to give excellent aberration to the optical axis shift of the objective lens caused when the objective lens follows the tracking operation. In addition, when a diffractive structure is provided, there is a tendency that utilization efficiency of light is lowered by vignetting of a ray of light.

In an optical pickup apparatus in which the whole of the coupling lens is made to be movable, a moving amount of the coupling lens needs to be large when switching a wavelength, for giving a prescribed divergence degree (convergence degree) to an objective lens for each of light fluxes having different wavelengths, which is disadvantageous for downsizing of an optical pickup apparatus. When using three light fluxes each having different wavelengths, a moving amount of the coupling lens is more increased, compared with an occasion for using two light fluxes each having a different wavelength, which results in a greater harmful effect for downsizing of an optical pickup apparatus. Furthermore, when a moving amount of the coupling lens is increased, power consumption of an actuator that drives the coupling lens is increased by just that much, which is a problem.

While, in the embodiment according to the present invention, there is provided the coupling lens formed of two or more lenses in two or more groups, one or more groups among them being made to be movable in the optical axis direction. Therefore, even when three light sources, a focal point of an objective lens and a light-receiving portion of the light-receiving element are made to be optically conjugate, it is not necessary to provide a diffractive surface on the coupling lens. Owing to this, the utilization efficiency of light can be highly secured, and the degree of freedom for an objective lens and a coupling lens is enhanced. For example, an aberration amount generated due to shift of the objective lens from the optical axis of the optical pickup apparatus caused by the objective lens following the tracking operation can be kept down. In addition, a moving amount of the coupling lens can be small, which is suitable for downsizing. In the structure of a conventional example, using three light fluxes each having a different wavelength, using one additional wavelength requires more larger moving amount for the coupling lens, compared with an occasion where two light fluxes each having a different wavelength are used. However, in the embodiment according to the present invention, it is possible to keep a moving amount of the coupling lens down, which is advantageous for downsizing. Incidentally, in the 2-group 2-element structure, it is preferable, from the viewpoint of downsizing and low cost, to employ the lens structure in which two aspheric lenses are provided (in other words, 2-group 2-element or two lenses in two groups) and one of them is made to be movable.

Item 6 is the optical pickup apparatus described in any one of Items 1-5 in which the first optical information recording medium is Blu-ray Disc or HD DVD, the second optical information recording medium is DVD and the third optical information recording medium is CD.

Item 7 is the optical pickup apparatus described in any one of Items 1-6 in which the coupling lens is composed of two lenses individually having aspheric surfaces.

Item 8 is the optical pickup apparatus described in any one of Item 1-7 in which the light flux splitter is a polarizing beam splitter, and a numerical aperture of the coupling lens at the light source side is 0.12 or less.

Item 9 is the optical pickup apparatus described any one of the Items 1-8 in which the optical pickup apparatus corrects a spherical aberration caused by a substrate thickness difference among the first to third optical information recording media by moving the at least one group of the lenses in the coupling lens along the optical axis.

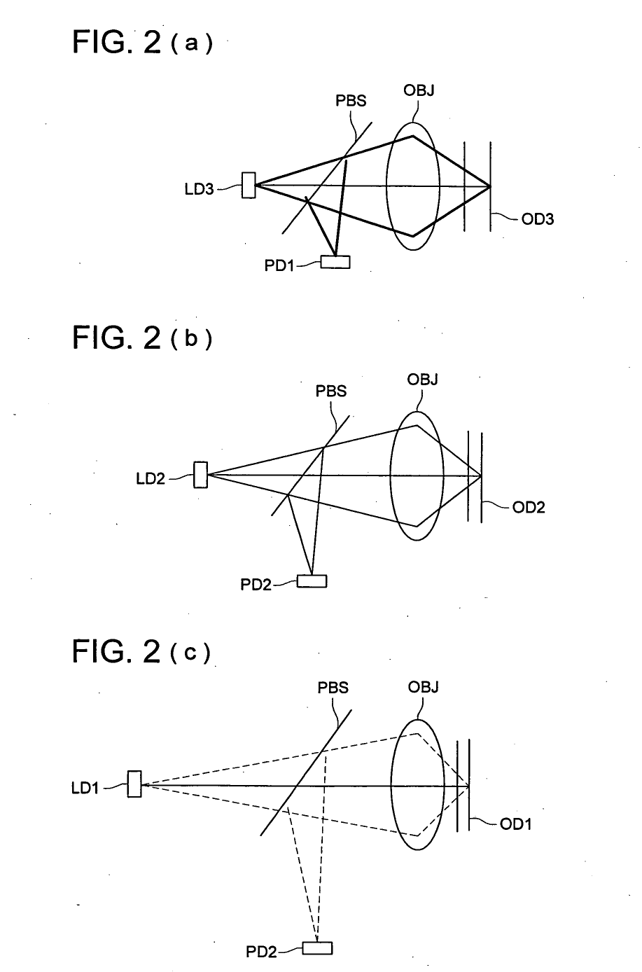

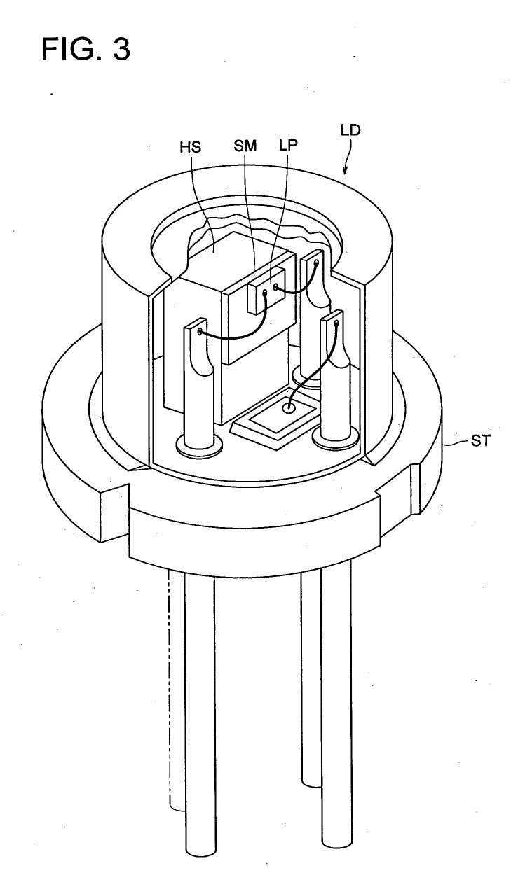

Item 10 is the optical pickup apparatus described any one of Items 1-9, wherein at least two of the first to third light sources are fixed on a common heat sink. For example, it is possible to realize downsizing and low cost of an optical pickup apparatus capable of conducting recording and/or reproducing of information compatibly, because an optical system can be simplified by using, for example, 2-wavelength 1-packaged laser device or 3-wavelength 1-packaged laser device. The “heat sink” means member HS or the like that supports light emitting points LP (for example, a laser chip for two wavelengths) capable of emitting two light fluxes on stem ST through submount SM, in 2-wavelength 1-packaged laser device LD shown in FIG. 3. An example of the 2-wavelength 1-packaged laser device LD of this kind is disclosed in Japanese Patent Application Publication Open to Public Inspection No. 2001-215435. Incidentally, when submount SM is attached directly on stem ST, the submount SM serves as a heatsink. When the light emitting points LP is attached directly on an elevated part of the stem ST, the stem ST serves as a heat sink.

Item 11 is the optical pickup apparatus described in any one of the Items 1-10 further includes a drive unit for driving the at least one group of the lenses in the coupling lens so as to be moved along the optical axis.

Item 12 is the optical pickup apparatus described in Item 11 in the drive unit inlcudes an electromechanical transducer; the driving member fixed to one end of the electromechanical transducer; and a movable member connected to the at lest one group of lenses in the coupling lens and movably supported on the driving member. The drive unit moves the movable member by repeatedly expanding and contracting at different speeds in extending direction and in contracting direction.

In the drive unit mentioned above, it is possible to cause the electromechanical transducer to transform to expand or contract microscopically, by impressing drive voltage such as, for example, a pulse having a serrated waveform for the extremely short period, and it is also possible to change a speed for expanding or for contracting, depending on a shape of the pulse. In this case, when the electromechanical transducer is transformed at a high speed in the expanding direction or in the contracting direction, the aforesaid movable member stays at its original position without actions following the drive member due to inertia of mass. On the other hand, when the electromechanical transducer is transformed at a speed lower than the aforesaid speed, the movable member moves, following the actions of the drive member with frictional force acting between them. Therefore, the movable member can move continuously in one direction when the electromechanical transducer repeats expanding and contracting. Namely, it is possible to move, at a high speed, the at least one group of lenses forming the coupling lens connected to the movable member, and also to move the at least one group of lenses by a minutely small amount by using a drive unit with a structure according to the invention that has a high response. Further, when holding, at the fixed position, the at least one group of lenses forming the coupling lens, by being discontinued electric power supply to the electromechanical transducer, the at least one group of lenses can be held by frictional force acting between the movable member and the drive member, which results also in energy saving. In addition, there is also an advantage that the structure of the drive unit is simple, small in size and is low cost.

Item 13 is the optical pickup apparatus described in any one of Items 1-12, further includes a lens positioned adjustably along the optical axis in an optical path between the coupling lens and at least one of the first light source, the second light source and the third light source, and in an optical path closer to the at least one of the light sources than the light flux splitter.

Though semiconductor lasers LD1-LD3 and the light-receiving portion in photodetector PD (light-receiving element) need to be positioned so that their optically conjugate relationship may hold, this relationship does not hold sometimes depending on errors in parts precisions and assembling precisions. Therefore, there is provided a lens that is positioned adjustably along the optical axis in an optical path between the coupling lens and at least one light source among the first, second and third light sources, and in an optical path that is closer to the at least one of the light sources than the light flux splitter, and the lens is moved and adjusted in the optical axis direction when the lens is assembled. It allows that focus offset mechanically caused by and positional error in the optical axis direction of the light source is corrected, and optically conjugate relationship between a semiconductor laser and light-receiving portion of photodetector (light-receiving element) is easily made to hold.

Further, when there is used the so-called 3-laser 1-packaged laser device in which three light sources are provided in one package, it is possible to provide a lens positionally adjustable along the optical axis for the package.

Meanwhile, it is preferable that two of the first, second and third light sources are equipped with the lenses positionally adjustable along the optical axis. Further, when there is used the so-called 2-laser 1-packaged laser device in which two light sources are provided in one package, it is preferable to the lens positionally adjustable along the optical axis for the package.

An optical pickup apparatus for correcting spherical aberration using a coupling lens formed of two or more elements in two or more groups for light fluxes with three different wavelengths provides an aberration change amount due to a position of the coupling lens, in the other words, a high error sensibility. Therefore, it is extremely difficult that the optical pickup apparatus completely suppresses each aberration of a spot formed by an objective lens on the information recording surface of the optical disc for every three wavelengths. Concretely, higher spherical aberration especially with fifth or more order remains in at least a light flux with one wavelength. Furthermore, the amount of the higher spherical aberration depends on a wavelength of the light flux. In order to downsize especially the optical pickup, it is required to reduce moving amount of the coupling lens for correcting spherical aberration. Residual of the higher spherical aberration is conspicuous in this case.

However, when the higher spherical aberration remains in a spot converged on the information recording surface of the optical disc, a light flux reflected on the information recording surface of the optical disc is formed into a spot with inhomogeneous light amount distribution on the light-receiving element, and it means the symmetry of the spot around the center of the spot is broken. As the result, the light flux reflected on the information recording surface of the optical disc is formed into a spot in different shape due to the wavelength of the light flux in the light-receiving element used for focus detection. It causes that focus error signal of each of light fluxes emitted from the light sources with different wavelengths is not same each other even when each of the light fluxes is under the focused condition on the information recording surface of the optical disc, in other words, it causes focus offset.

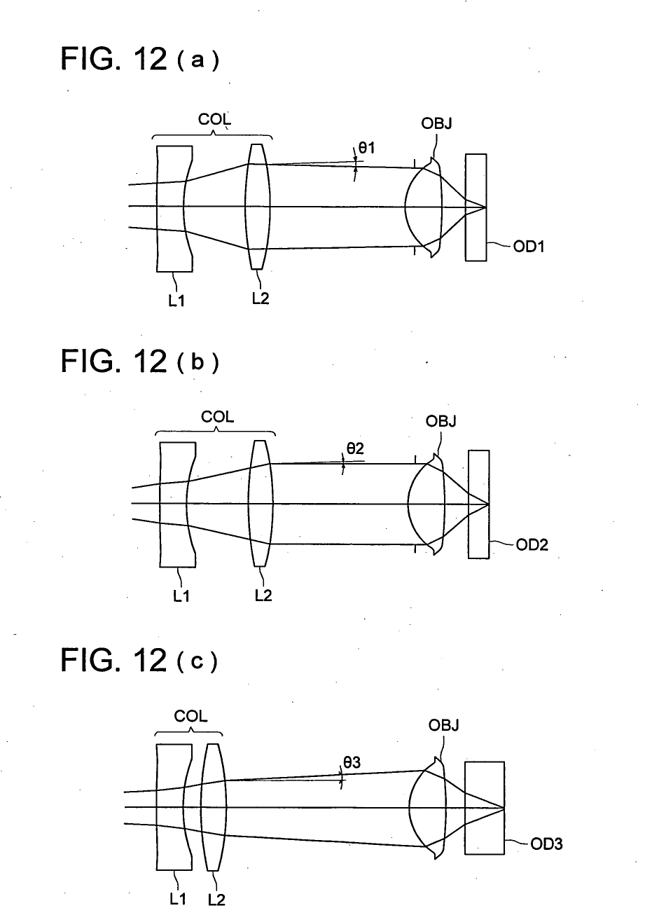

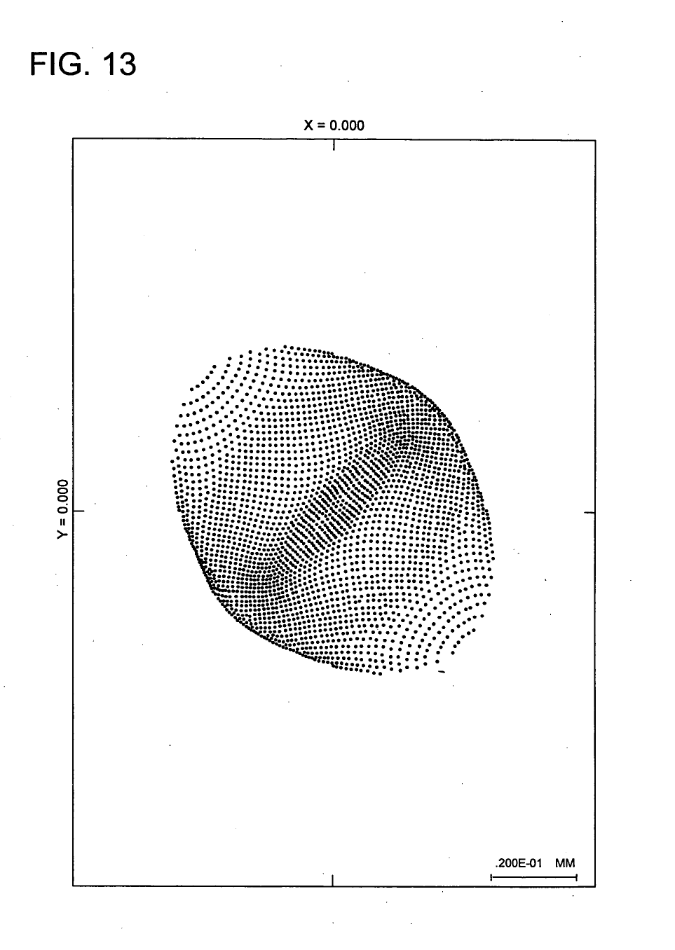

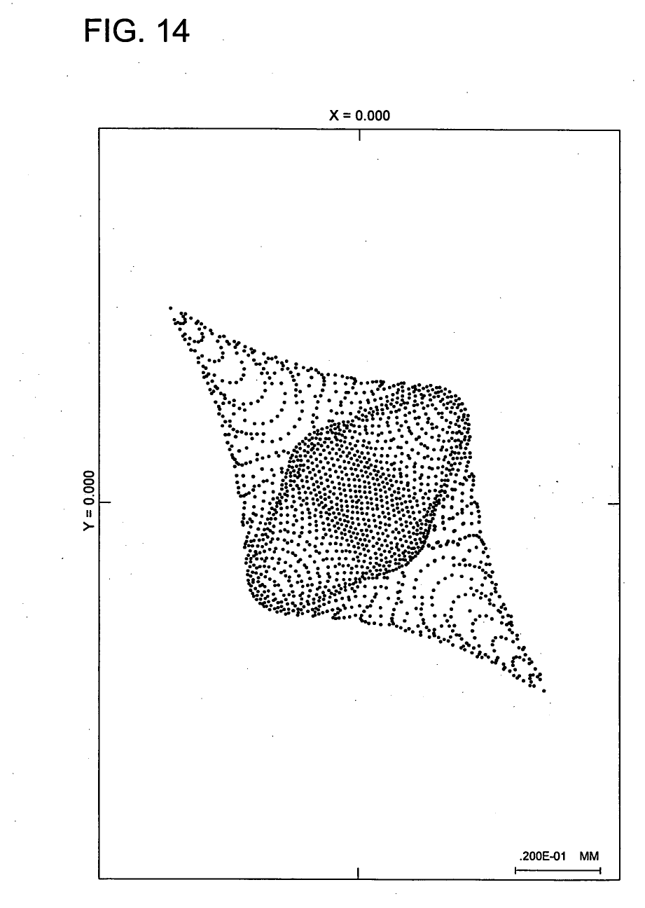

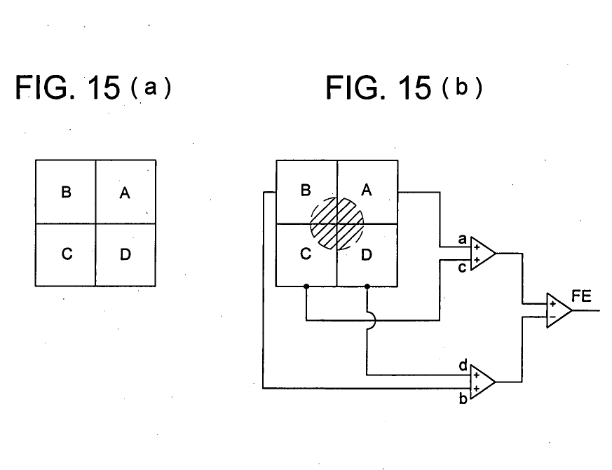

For example, the focus offset caused when an astigmatism method is utilized for the focus detecting method is described using FIGS. 13, 14, 15(a), and 15(b). FIG. 13 shows an example of a spot formed from the light flux with the wavelength 407.0 nm reflected on the information recording surface of the optical disc and formed on the light-receiving portion. FIG. 14 shows an example of a spot formed from the light flux with the wavelength 785.0 nm reflected on the information recording surface of the optical disc and formed on the light-receiving portion. FIG. 15(a) shows the front view of the four-quadrant light-receiving portion that the light-receiving portion is divided quadrants arranged in 2×2 matrix and FIG. 15(b) shows a circuit for obtaining focus error signal from the four-quadrant light-receiving portion by the astigmatism method. When the spot formed on the information recording surface of the optical disc has the different higher order spherical aberration, light fluxes with different wavelengths reflected by the information recording surface of the optical disc are formed into the spots in different shapes as shown in FIGS. 13 and 14. Table 1 and Table 2 show coefficient values of ZERNIKE polynomial in which aberration of the converged spot on the recording surface of the optical disc corresponding to FIGS. 13 and 14 is expanded, respectively.

TABLE 1
FRINGE ZERNIKE POLYNOMIAL COEFFICIENTS

| Number | Value (waves at 407.0 nm) |
|---|---|
| 1 | 0.0000 |
| 2 | 0.0000 |
| 3 | 0.0000 |
| 4 | 0.0003 |
| 5 | 0.0000 |
| 6 | 0.0000 |
| 7 | 0.0000 |
| 8 | 0.0000 |
| 9 | −0.0214 |
| 10 | 0.0000 |
| 11 | 0.0000 |
| 12 | 0.0000 |
| 13 | 0.0000 |
| 14 | 0.0000 |
| 15 | 0.0000 |
| 16 | 0.0030 |
| 17 | 0.0000 |
| 18 | 0.0000 |
| 19 | 0.0000 |
| 20 | 0.0000 |
| 21 | 0.0000 |
| 22 | 0.0000 |
| 23 | 0.0000 |
| 24 | 0.0000 |
| 25 | −0.0056 |
| RMS of polynomial = | 0.0098 |
| (tilt removed) | 0.0098 |
| RMS fit error = | 0.0007 |

TABLE 2
FRINGE ZERNIKE POLYNOMIAL COEFFICIENTS

| Number | Value (waves at 785.0 nm) |
|---|---|
| 1 | −0.0001 |
| 2 | 0.0000 |
| 3 | 0.0000 |
| 4 | −0.0005 |
| 5 | 0.0000 |
| 6 | 0.0000 |
| 7 | 0.0000 |
| 8 | 0.0000 |
| 9 | 0.0034 |
| 10 | 0.0000 |
| 11 | 0.0000 |
| 12 | 0.0000 |
| 13 | 0.0000 |
| 14 | 0.0000 |
| 15 | 0.0000 |
| 16 | −0.0253 |
| 17 | −0.0002 |
| 18 | 0.0000 |
| 19 | 0.0000 |
| 20 | 0.0000 |
| 21 | 0.0000 |
| 22 | 0.0000 |
| 23 | 0.0000 |
| 24 | 0.0000 |
| 25 | −0.0051 |
| RMS of polynomial = | 0.0098 |
| (tilt removed) | 0.0098 |
| RMS fit error = | 0.0020 |

A shown in Table 1 and Table 2, the spot converged on the information recording surface of the optical disc shown in FIG. 14 has the larger fifth spherical aberration, while it has almost same whole aberration being 0.0098 arms, the smaller ninth coefficient which is the third aspheric aberration, comparing to those of the spot converged on the information recording surface of the optical disk shown in FIG. 13.

When the higher spherical aberration is increased like this, symmetry around the axis which is the center of the spot formed on the light-receiving portion is significantly broken as shown in FIG. 14. On the other hand, focus error signal FE by the astigmatism method is provided by an operation expression for the output: FE=(a+b)−(b+d), where each of a, b, c, and d is photoelectric output from quadrants (A, B, C, and D) of the four-quadrate light-receiving portion. When the higher spherical aberration in the light flux reflected by the information recording surface of the optical disc is small, the spot formed on the receiving element is symmetry around its center. However, when the higher spherical aberration in the light flux reflected by the information recording surface of the optical disc is large, symmetry of the spot formed on the receiving element around its center is significantly broken. Therefore, focus error signal corresponding to each wavelength does not become same value in an optical pickup apparatus using light sources with a plurality of wavelengths, in the other words, it makes focus offset.

However, the focus offset is corrected when a lens is adjustably positioned along the optical axis in an optical path which is between at least one of the first to third light sources, and a coupling lens formed of two or more lenses in two or more groups, and which is closer to one of the light sources than the light flux splitter, and when the lens is adjusted by being moved along the optical axis at the case of assembly. In the other words, when the light fluxes with three kinds of wavelengths pass through the coupling lens formed of two or more elements in two or more groups and the spherical aberration is corrected by changing distance between elements of the coupling lens, the higher spherical aberration can be caused. In this case optical conjunction relation between the semiconductor laser and a light-receiving portion of a photodetector (light-receiving element) is also easily achieved.

Herein, however the example using the astigmatism method as the focus error detecting method is provided, other methods such as Foucault method, knife-edge method and beam size method are also utilized. It is naturally shown that the higher spherical aberration of the spot converged on the information recording surface of the optical disc affects a shape of the spot converted on the light-receiving element and it is effective when using these methods.

The invention makes it possible to provide an optical pickup apparatus that can conduct recording and/or reproducing of information compatibly for at least three types of optical information recording media, by using a common objective lens and a common photodetector.

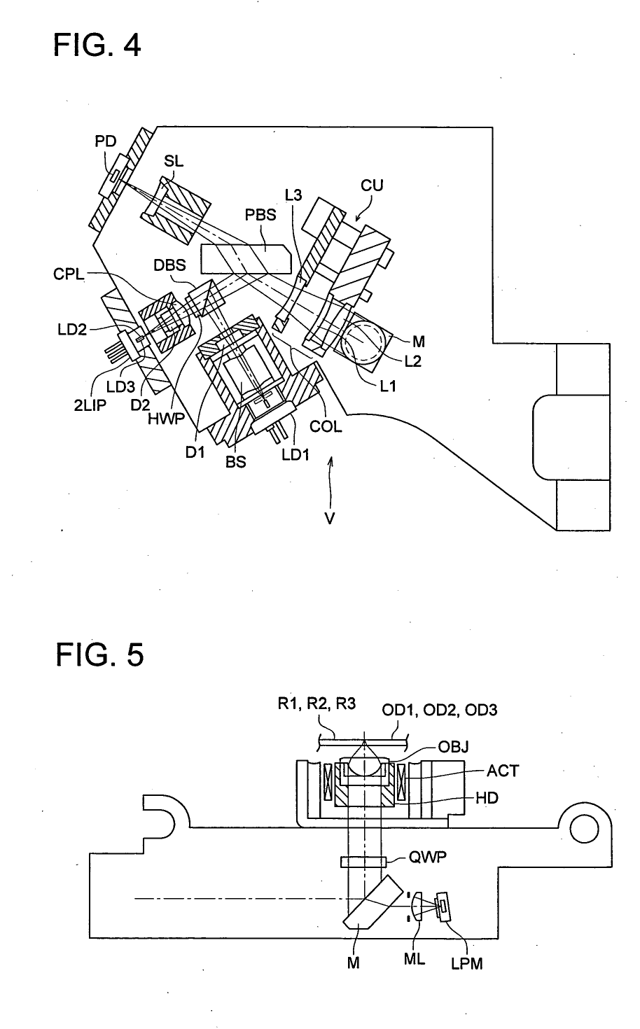

An embodiment of the invention will be explained as follows, referring to the drawings. FIG. 4 is a top view showing schematically the structure of an optical pickup apparatus according to the first embodiment capable of conducting recording and/or reproducing of information properly for BD (Blu-ray Disc) or HD DVD, DVD and CD which are optical information recording media each having a different protective substrate thickness. FIG. 5 is a side view in which the present embodiment is viewed in the direction of arrow V shown in FIG. 4. In the present embodiment, objective lens OBJ and coupling lens COL are included as a converging optical system. The coupling lens COL is composed of the first group (lenses L1, L2) and the second group (lens L3), in which the second group is movable along the optical axis. Though a diffractive structure is not formed on lenses L1-L3, it may also be formed on them. Though there is used the so-called 2-laser 1-packaged laser device wherein the second semiconductor laser LD2 representing the second light source and the third semiconductor laser LD3 representing the third light source are housed in the same package, or fixed on the same heat sink, in the present embodiment, the semiconductor lasers may also be arranged individually. Three semiconductor lasers LD1-LD3 and light-receiving portion of photodetector (light-receiving element) PD are mutually in the optically conjugate relationship through information recording surfaces of optical discs of OD1-OD3.

Incidentally, when all positions of light emitting points of semiconductor lasers LD1-LD3 for the optical axis of a converging optical system are different each other, or when positions of light emitting points of two semiconductor lasers agree each other and the other one is deviated, light-converging positions on a light-receiving portion of photodetector (light-receiving element) PD are different based on the deviation of the position of light emitting point of the semiconductor laser. Therefore, when there are deviations for positions of light emitting points of semiconductor lasers LD1-LD3 for the optical axis of the converging optical system of this kind, there is used one equipped with plural light-receiving areas corresponding to the deviation, as photodetector (light-receiving element) PD.

When conducting recording and/or reproducing of information for the first optical disc OD1 (for example, BD or HD DVD), the second group of coupling lens COL is moved to the first position in the optical axis direction, so that the light flux emitted from semiconductor laser LD1 may enter objective lens OBJ at the first divergent angle θ1 (see FIG. 12(a)). In this case, in the optical pickup apparatus shown in FIG. 4, a light flux emitted from semiconductor laser LD1 with light source wavelength 390-420 nm (first light source) is shaped by beam-shaping element BS in terms of its shape, then, is separated into a main beam for recording and reproducing and a sub-beam for detecting tracking error signals by passing further the first diffractive element D1, then, is reflected by dichroic beam splitter DBS and is reflected by polarization beam splitter PBS, then, it passes through coupling lens COL to acquire the first divergent angle θ1 and enters raising mirror M. Meanwhile, operations of the coupling lens COL will be described later.

In FIG. 5, a part of a light flux which has entered the raising mirror M passes through monitor lens after being transmitted through the raising mirror M, and enters laser power monitor LPM to be used for monitoring of laser power on the other hand, the remainder of the light flux which has entered the raising mirror M is reflected there, and it passes through quarter wavelength plate QWP, and then, enters objective lens OBJ (the number of elements may also be one although it is two in the present embodiment) from which the remainder of the light flux is converged on information recording surface R1 of optical disc OD1 (thickness of protective substrate, 0.1 mm or 0.6 mm).

The reflected light flux modulated by information pits on information recording surface R1 passes again through objective lens OBJ and quarter wavelength plate QWP, and passes through coupling lens COL after being reflected by raising mirror M, and further passes through polarization beam splitter PBS, to be converged on a light-receiving portion of photodetector (light-receiving element) PD by sensor lens SL. Signals for reading information recorded on optical disc OD1 can be obtained by using output signals of the photodetector PD.

Further, detection of focusing operation and detection of tracking operation are conducted by detecting a change in an amount of light caused by changes in shapes and positions of spots on the photodetector PD. Objective lens OBJ is arranged to be moved together with lens holder HD solidly so that a focusing actuator of objective lens actuator mechanism ACT and a tracking actuator may converge a light flux emitted from the first semiconductor laser LD1, based on this detection, to form an image properly on information recording surface R1 of optical disc OD1.

When conducting recording and/or reproducing of information for the second optical disc OD2 (for example, DVD), the second group of the coupling lens COL is moved to the second position in the optical axis direction, so that a light flux emitted from semiconductor laser LD2 may enter the objective lens OBJ at the second divergent angle θ2 (see FIG. 12(b)). In this case, in the optical pickup apparatus shown in FIG. 4, a light flux emitted from semiconductor laser LD2 with light source wavelength 630-670 nm passes through the second diffractive element D2 after getting out of 2-laser 1-packaged laser device, to be separated into a main beam for recording and reproducing and a sub-beam for detecting tracking error signals, and is adjusted by coupling lens CPL in terms of a divergent angle, then, it passes through half wavelength plate HWP and dichroic bean splitter DBS, and is reflected by polarization beam splitter PBS, then, it passes through coupling lens COL to acquire the second divergent angle θ2 and enters raising mirror M.

In FIG. 5, a part of a light flux which has entered raising mirror M passes through monitor lens after being transmitted through the raising mirror M, and enters laser power monitor LPM to be used for monitoring of laser power. On the other hand, the remainder of the light flux which has entered the raising mirror M is reflected there, and it passes through quarter wavelength plate QWP, and then, enters objective lens OBJ from which the remainder of the light flux is converged on information recording surface R2 of optical disc OD2 (thickness of protective substrate, 0.6 mm).

The reflected light flux modulated by information pits on information recording surface R2 passes again through objective lens OBJ and quarter wavelength plate QWP, and passes through coupling lens COL after being reflected by raising mirror M, and further passes through polarization beam splitter PBS, to be converged on a light-receiving portion of photodetector PD by sensor lens SL. Signals for reading information recorded on optical disc OD2 can be obtained by using output signals of the photodetector PD.

Further, detection of focusing operation and detection of tracking operation are conducted by detecting a change in an amount of light caused by changes in shapes and positions of spots on the photodetector PD. Objective lens OBJ is arranged to be moved together with lens holder HD solidly so that a focusing actuator of objective lens actuator mechanism ACT and a tracking actuator may converge a light flux emitted from the second semiconductor laser LD2, based on this detection, to form an image properly on information recording surface R2 of optical disc OD2.

When conducting recording and/or reproducing of information for the third optical disc OD3 (for example, CD), the second group of the coupling lens COL is moved to the third position in the optical axis direction, so that a light flux emitted from semiconductor laser LD3 may enter the objective lens OBJ at the third divergent angle θ3 (see FIG. 12(c)). In this case, in the optical pickup apparatus shown in FIG. 4, a light flux emitted from semiconductor laser LD3 with light source wavelength 760-800 nm passes through the second diffractive element D2 after getting out of 2-laser 1-packaged laser device, to be separated into a main beam for recording and reproducing and a sub-beam for detecting tracking error signals, and is adjusted by coupling lens CPL in terms of a divergent angle, then, it passes through half wavelength plate HWP and dichroic bean splitter DBS, and is reflected by polarization beam splitter PBS, then, it passes through coupling lens COL to acquire the third divergent angle θ3 and enters raising mirror M. Meanwhile, under the assumption, for each of divergent angles of incident light fluxes entering objective lens OBJ, that the divergent angle in case the incident light flux enters under the condition of divergence is positive and the divergent angle in case the incident light flux enters under the condition of convergence is negative, θ1<0 is for FIG. 12(a), θ2<0 is for FIG. 12(b), and θ3>0 is for FIG. 12(c).

In FIG. 5, a part of a light flux which has entered the raising mirror M passes through monitor lens after being transmitted through the raising mirror M, and enters laser power monitor LPM to be used for monitoring of laser power. On the other hand, the remainder of the light flux which has entered the raising mirror M is reflected there, and it passes through quarter wavelength plate QWP, and then, enters objective lens OBJ from which the remainder of the light flux is converged on information recording surface R3 of optical disc OD3 (thickness of protective substrate, 1.2 mm).

The reflected light flux modulated by information pits on information recording surface R3 passes again through objective lens OBJ and quarter wavelength plate QWP, and passes through coupling lens COL after being reflected by raising mirror M, and further passes through polarization beam splitter PBS, to be converged on a light-receiving portion of photodetector PD by sensor lens SL. Signals for reading information recorded on optical disc OD3 can be obtained by using output signals of the photodetector PD.

Further, detection of focusing operation and detection of tracking operation are conducted by detecting a change in a light amount caused by changes in shapes and positions of spots on the photodetector PD. Objective lens OBJ is arranged to be moved together with lens holder HD solidly so that a focusing actuator of objective lens actuator mechanism ACT and a tracking actuator may converge a light flux emitted from the third semiconductor laser LD3, based on this detection, to form an image properly on information recording surface R3 of optical disc OD3.

Since the coupling lens COL is of the 2-group 3-elements structure, and a distance of an air space between the groups is variable along the optical axis as described later, in the present embodiment, it is possible to change a divergent angle depending on a wavelength of a light flux emitted from each of respective semiconductor lasers LD1-LD3 and on a thickness of protective substrate, by changing the distance of air space, and to form an appropriate focused spot on an information recording surface of each of optical discs OD1-OD3.

In this case, each of three semiconductor lasers LD1 LD3 and a light-receiving portion of photodetector (light-receiving element) PD are mutually in the optically conjugate relationship through each of information recording surfaces of respective optical discs OD1-OD3. Specifically, in case the second group of coupling lens COL is at the first position in the optical axis direction, semiconductor laser LD1 and a light-receiving portion of photodetector (light-receiving element) PD are mutually in the optically conjugate relationship through an information recording surface of the first optical disc OD1.

Further, in case the second group of coupling lens COL is at the second position in the optical axis direction, semiconductor laser LD2 and a light-receiving portion of photodetector PD are mutually in the optically conjugate relationship through an information recording surface of the second optical disc OD2.

Furthermore, in case the second group of coupling lens COL is at the third position in the optical axis direction, semiconductor laser LD3 and a light-receiving portion of photodetector PD are mutually in the optically conjugate relationship through an information recording surface of the third optical disc OD3.

As stated above, semiconductor lasers LD1-LD3 and a light-receiving portion of photodetector (light-receiving element) PD need to be positioned so that optically conjugate relationship may hold, but this relationship does not hold sometimes, depending on errors in parts precisions and assembling precisions.

In this case, it is possible to correct focus offset caused by errors of mechanical positions in the optical axis direction of the light source, by making the position of the coupling lens CPL in the optical axis direction to be adjustable for movement, and thereby to move and adjust in the optical axis direction in the course of assembling, and the semiconductor laser and the light-receiving portion of photodetector (light-receiving element) PD can make the optically conjugate relationship to hold.

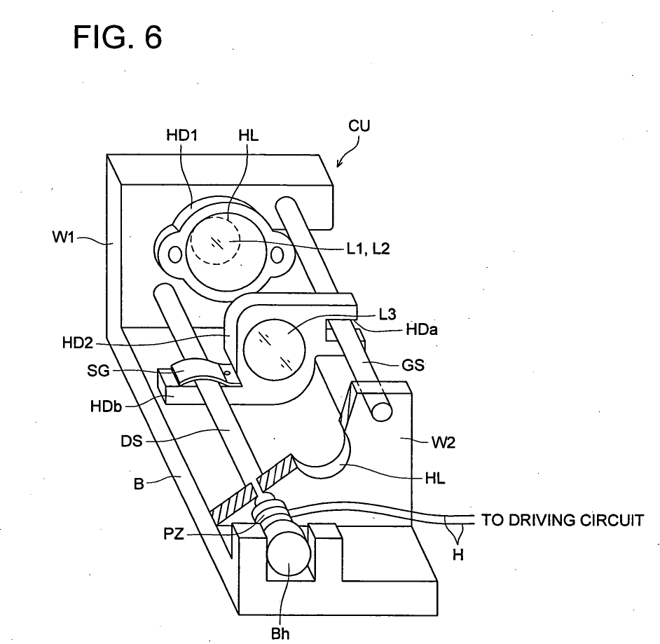

FIG. 6 is a perspective view of optical system unit CU housing therein coupling lens COL and its drive unit integrally. In FIG. 6, walls W1 and W2 are standing upward at both ends of base B. Guide shaft GS extends to connect upper portions of the walls W1 and W2 (whose upper portion is cut to be illustrated). On each of the walls W1 and W2, there is formed hole HL through which a light flux passes.

Lens L1 and lens L2 are held by lens holder HD1 by their outer circumferences, and the lens holder is screwed so that it covers the hole HL. When incorporating the lenses L1 and L2, it is preferable to restrain shift and tilt against a reference shaft as far as possible, by using an automatic collimator or the like.

On the other hand, lens L3 representing a movable element is supported by its outer circumference by lens holder HD2. The lens holder HD2 serving as a movable element has therein engagement section HDa that engages with guide shaft GS and connection section HDb that receives driving force.

The connection section HDb is provided with a groove that comes in contact with drive shaft DS, and leaf spring SG is attached on the top surface of the connection section HDb. Between the connection section HDb and leaf spring SG, there is arranged drive shaft DS representing a drive member, and it is pressed properly by urging force of the leaf spring SG. A clearance is provided on the wall W1 side of the drive shaft DS, and the other end portion is right through wall W2 and is connected to piezoelectric actuator PZ representing an electromechanical conversion element. The piezoelectric actuator PZ has fixing section Bh and is fixed on base B outside W2 by the way of adhesion.

On the base B, there is arranged an outer drive circuit (not shown) that impresses voltage through wiring H, for the purpose of receiving signals from an unillustrated encoder (which is a position detecting means, and for example, magnetic information can be arranged on guide shaft GS and a reading head can be provided on engagement section HDa) that detects a moving amount of the connection section HDb magnetically (or optically), and of conducting control of drive of the piezoelectric actuator PZ. The piezoelectric actuator PZ, the drive shaft DS, the connection section HDb and the leaf spring SG constitute a drive unit. Incidentally, the drive circuit may also be arranged on the base B to be connected through wiring.

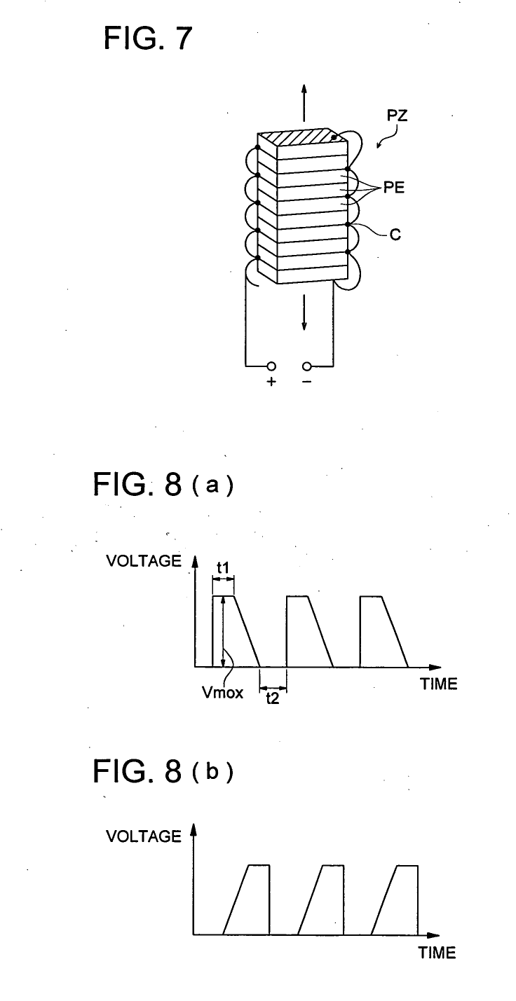

Piezoelectric ceramics formed with PZT (lead zirconate titanate) and others are laminated to constitute piezoelectric actuator PZ. In the piezoelectric ceramic, a center of gravity of positive electric charge in its crystal grating is not in accord with that of negative electric charge, and itself is polarized and has properties to extend if voltage is impressed in the direction of the polarization. However, a strain of the piezoelectric ceramic in this direction is minute, and it is difficult to drive a member to be driven with an amount of this strain. Therefore, there are available lamination type piezoelectric actuators PZ each having the structure wherein plural piezoelectric ceramics PE are laminated, and electrodes C are connected in parallel between them as those which are suitable of practical use, as shown in FIG. 7. In the present embodiment, this lamination type piezoelectric actuator PZ is used as a driving source.

How to drive the lens L3 with this optical system unit CU will be explained as follows. In general, generative force of the lamination type piezoelectric actuators PZ is great and its response is sharp when voltage is applied thereon, although an amount of its displacement is small. Therefore, when there is impressed a pulse voltage having a substantially serrated waveform in which a rise curve is sharp and a fall curve is gentle as shown in FIG. 8(a), the piezoelectric actuators PZ extends suddenly in the course of rising of the pulse, and shrinks slowly in the course of falling of the pulse. Therefore, when the piezoelectric actuators PZ extends, its impulse force pushes out drive shaft DS toward a back side (wall W1 side) in FIG. 6. However, connection section HDb of the lens holder HD2 that holds lens L3 and leaf spring SG are not moved together with the drive shaft DS due to their inertia, to slide on the drive shaft DS and stay at their original positions (connection section HDb and leaf spring SG are sometimes moved slightly). On the other hand, in the course of a fall of the pulse, the drive shaft DS returns slowly compared with a rise, and therefore, the connection section HDb and the leaf spring SG do not slide on the drive shaft DS, but move solidly with the drive shaft DS toward this side (wall W2 side) in FIG. 6. Namely, it is possible to move the lens holder HD2 continuously at a desired speed, by impressing a pulse whose frequency is set to hundreds hertz—tens of thousands hertz. Incidentally, it is possible to move the lens holder HD2 in the opposite direction by impressing a pulse having a waveform in which a rise curve is gentle and a fall curve is sharp as shown in FIG. 8(b), which is clear from the foregoing. In particular, if the guide shaft GS is straight, the lens holder HD2 can move accurately in the optical axis direction, and aberration deterioration can be restrained effectively, compared with an occasion where optical axis deviation is caused by driving.

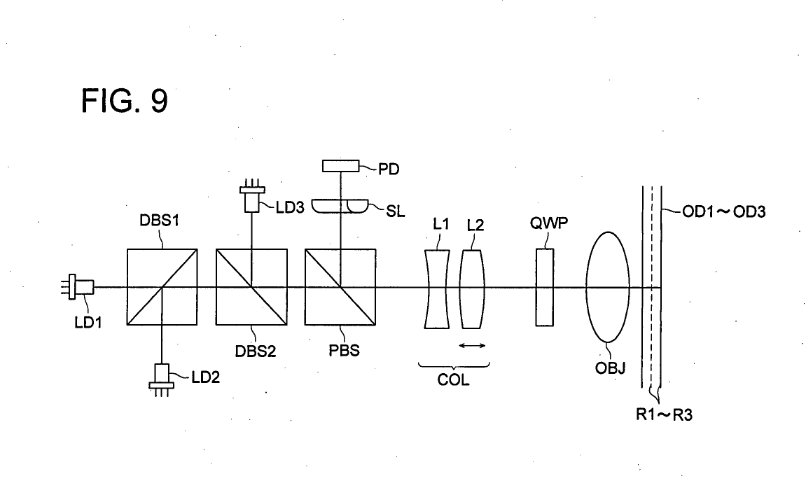

FIG. 9 is a top view showing schematically the structure of an optical pickup apparatus according to the second embodiment capable of conducting recording and/or reproducing of information properly for BD (Blu-ray Disc) representing optical information recording media each having a different protective substrate thickness, or HD DVD, DVD and CD. Even in the present embodiment, objective lens OBJ and coupling lens COL are included as a converging optical system. The coupling lens COL is composed of the first group (lens L1) and the second group (lens L2), and the second group is movable along the optical axis in this case. As a drive unit for the second group, structures shown in FIGS. 6, 7, and 8(a)-8(b) can be used. Each of lens L1 and lens L2 has an aspheric surface, and a diffractive structure is not formed thereon. However, the diffractive structure may also be formed on thereon. Three semiconductor lasers LD1-LD3 and a light-receiving portion of photo-detector (light-receiving element) PD are in the optically conjugate relationship through information recording surfaces of respective optical discs OD1-OD3.

When conducting recording and/or reproducing of information for the first optical disc OD1 (for example, BD or HD DVD), the second group of the coupling lens COL is moved to the first position in the optical axis direction so that a light flux emitted from the semiconductor laser LD1 may enter the objective lens OBJ at the first divergent angle θ1. In this case, in an optical pickup apparatus shown in FIG. 9, a light flux of P-polarized light emitted from semiconductor laser LD1 (first light source) having a light source wavelength of 390-420 nm passes through first dichroic prism DBS1, second dichroic prism DBS2 and polarized beam splitter PBS, then, passes through coupling lens COL to be of first divergent angle θ1, and enters the objective lens OBJ after passing through quarter wavelength plate QWP, to be converged on information recording surface R1 (protective substrate thickness 0.1 mm or 0.6 mm) of optical disc OD1.

A reflected light flux modulated by information pits on information recording surface R1 passes again through objective lens OBJ and quarter wavelength plate QWP to become S polarized light, then, passes through coupling lens COL, and is reflected by polarization beam splitter PBS, to be converged on a light-receiving portion of photodetector (light-receiving element) PD by sensor lens SL. Reading signals for information recorded on optical disc OD1 can be obtained by using output signals of photodetector PD.

Further, detection of focusing operation and detection of tracking operation are conducted by detecting a change in a light amount caused by changes in shapes and positions of spots on the photodetector PD. Based on these detections, a focusing actuator and a tracking actuator in the objective lens actuator mechanism (not shown) move the objective lens OBJ solidly with lens holder HD, so that a light flux emitted from the first semiconductor laser LD1 may form an image properly on information recording surface R1 of optical disc OD1.

When conducting recording and/or reproducing of information for the second optical disc OD2 (for example DVD), the second group of the coupling lens COL is moved to the second position in the optical axis direction so that a light flux emitted from the semiconductor laser LD2 may enter the objective lens OBJ at the second divergent angle θ2. In this case, in an optical pickup apparatus shown in FIG. 9, a light flux of P polarized light emitted from semiconductor laser LD2 (second light source) having a light source wavelength of 630-670 nm is reflected by the first dichroic prism DBS1 and passes through second dichroic prism DBS2 and polarized beam splitter PBS, then, passes through coupling lens COL to be of second divergent angle θ2, and enters the objective lens OBJ after passing through quarter wavelength plate QWP, to be converged on information recording surface R2 (protective substrate thickness 0.6 mm) of optical disc OD2.

A reflected light flux modulated by information pits on information recording surface R2 passes again through objective lens OBJ and quarter wavelength plate QWP to become S polarized light, then, passes through coupling lens COL, and is reflected by polarization beam splitter PBS, to be converged on a light-receiving portion of photodetector (light-receiving element) PD by sensor lens SL. Reading signals for information recorded on optical disc OD2 can be obtained by using output signals of photodetector PD.

Further, detection of focusing operation and detection of tracking operation are conducted by detecting a change in a light amount caused by changes in shapes and positions of spots on the photodetector PD. Based on these detections, a focusing actuator and a tracking actuator in the objective lens actuator mechanism (not shown) move the objective lens OBJ solidly with lens holder HD, so that a light flux emitted from the second semiconductor laser LD2 may form an image properly on information recording surface R2 of optical disc OD2.

When conducting recording and/or reproducing of information for the third optical disc OD3 (for example CD), the second group of the coupling lens COL is moved to the third position in the optical axis direction so that a light flux emitted from the semiconductor laser LD3 may enter the objective lens OBJ at the third divergent angle θ3. In this case, in an optical pickup apparatus shown in FIG. 9, a light flux of P polarized light emitted from semiconductor laser LD3 (third light source) having a light source wavelength of 760-800 nm is reflected by the second dichroic prism DBS2 and passes through polarized beam splitter PBS, then, passes through coupling lens COL to be of third divergent angle θ3, and enters the objective lens OBJ after passing through quarter wavelength plate QWP, to be converged on information recording surface R3 (protective substrate thickness 1.2 mm) of optical disc OD3.

A reflected light flux modulated by information pits on information recording surface R3 passes again through objective lens OBJ and quarter wavelength plate QWP to become S polarized light, then, passes through coupling lens COL, and is reflected by polarization beam splitter PBS, to be converged on a light-receiving portion of photodetector (light-receiving element) PD by sensor lens SL. Reading signals for information recorded on optical disc OD3 can be obtained by using output signals of photodetector PD.

Further, detection of focusing operation and detection of tracking operation are conducted by detecting a change in a light amount caused by changes in shapes and positions of spots on the photodetector PD. Based on these detections, a focusing actuator and a tracking actuator in the objective lens actuator mechanism (not shown) move the objective lens OBJ solidly with lens holder HD, so that a light flux emitted from the third semiconductor laser LD3 may form an image properly on information recording surface R3 of optical disc OD3.

In the present embodiment, three light fluxes each having a different wavelength emitted from a light source pass through polarization beam splitter PBS provided to be closer to the light source than the coupling lens COL is, and three light fluxes each having a different wavelength reflected on an optical disc are reflected on the polarization beam splitter PBS. For these three wavelengths λ1, λ2 and λ3, there are required coating characteristics in which Tp (light transmission of P polarization) is preferably equal to and greater than 80% and Rs (light transmission of S polarization) is preferably equal to and greater than 80%. For attaining this, if NA (numerical aperture) of the coupling lens on the light source side is set to 1.2 or less, the number of layers of the polarization beam splitter PBS has only to be 40 or less, which is advantageous for cost reduction of the polarization beam splitter PBS. Further, by moving the second group among two lens groups constituting the coupling lens COL in the optical axis direction, it is also possible to restrain occurrence of spherical aberration caused by a change in optical disc thickness.

Incidentally, a type of the polarization beam splitter PBS includes a type wherein a polarization beam splitter surface formed does not come in contact with air, and a type wherein a polarization beam splitter surface formed comes in contact with air. Among the aforesaid types, design and manufacturing for the coat wherein beam incident angle dependency of polarization beam splitter property is restrained are easier for the polarization beam splitter PBS of a type in which a formed polarization beam splitter surface is interposed by glass and does not come in contact with air as in the aforesaid embodiment. Therefore, in the optical pickup apparatus wherein optical elements are arranged so that a light flux emerging from the polarization beam splitter surface may enter coupling lens COL without changing its divergent angle, it is desirable to use a polarization beam splitter of a type in which a formed polarization beam splitter surface does not come in contact with air, when NA of the coupling lens COL on the light source side is made to be a relatively large value of 0.05 or more. In particular, when NA of the coupling lens COL on the light source side is 0.07 or more, a polarization beam splitter of a type in which a formed polarization beam splitter surface does not come in contact with air is preferable from a viewpoint of capability and cost.

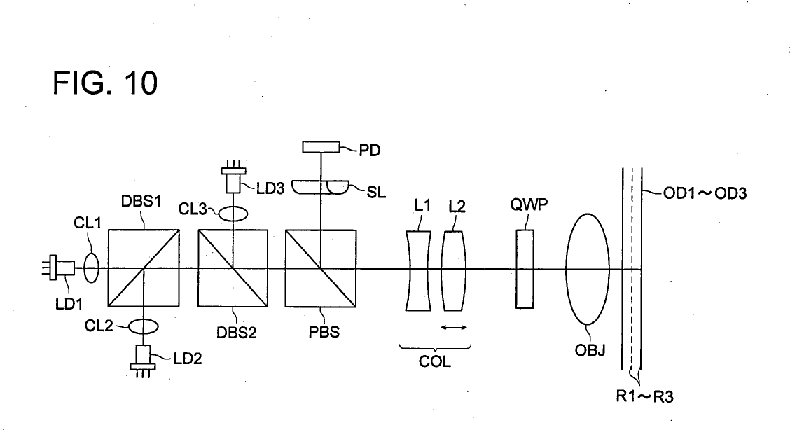

FIG. 10 is a top face view showing schematically the structure of the optical pickup apparatus relating to the third embodiment capable of conducting recording and/or reproducing of information properly for BD (Blu-ray Disc) or HD DVD, DVD and CD which are optical information recording media each having a different protective substrate thickness. The present embodiment is different from that shown in FIG. 9 only on the point that coupling lens CL1 is positioned between the first semiconductor laser LD1 and the first dichroic prism DBS1, coupling lens CL2 is positioned between the second semiconductor laser LD2 and the first dichroic prism DBS2 and coupling lens CL3 is positioned between the third semiconductor laser LD3 and the second dichroic prism DBS2. Even in the present embodiment, three semiconductor lasers LD1-LD3 and a light-receiving portion of photodetector (light-receiving elements) PD are mutually in the optically conjugate relationship through information recording surfaces of optical discs of OD1-OD3.

In the present embodiment, light fluxes emitted from respective semiconductor lasers LD1-LD3 are transformed by respective coupling lenses CL1-CL3 into parallel light fluxes, thus, all of them enter coupling lens COL in the form of a parallel light flux. However, in the coupling lens COL, the second group therein is moved to the first-third positions in the optical axis direction depending on the optical disc to be used, so that each light flux may emerge at a prescribed divergent angle to enter objective lens OBJ, thus, the spherical aberration can be restrained as stated above.

Incidentally, though semiconductor lasers LD1-LD3 and a light-receiving portion of photodetector (light-receiving element) PD need to be positioned to keep the optically conjugate relationship, this relationship sometimes cannot be kept due to errors in parts precisions and assembling precisions.

In this case, at least two coupling lenses (for example, CL2 and CL3) of coupling lenses CL1, CL2 and CL3 are made to be movable and is positionaly adjusted along the optical axis, and by moving and positionaly adjusting in the optical axis direction in the course of assembling, it is possible to correct focus offset caused by errors in mechanical positions in the optical axis direction of the light source, and thereby to make the optically conjugate relationship to hold easily between a semiconductor laser and a light-receiving portion of photodetector (light-receiving element) PD.

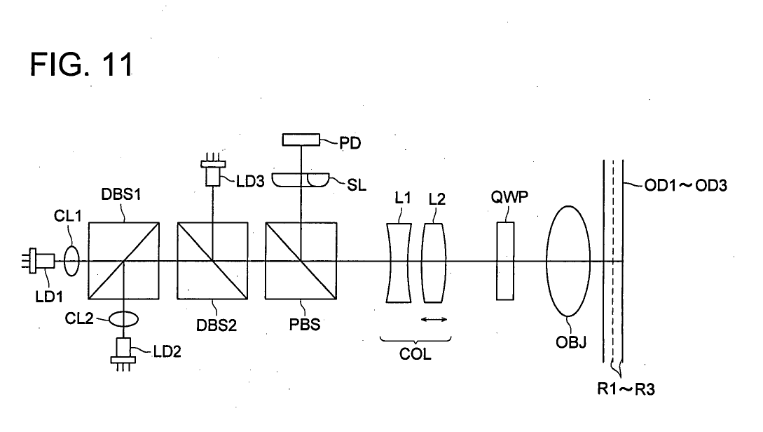

FIG. 11 is a top face view showing schematically the structure of the optical pickup apparatus relating to the fourth embodiment capable of conducting recording and/or reproducing of information properly for BD (Blu-ray Disc) or HD DVD, DVD and CD which are optical information recording media each having a different protective substrate thickness. The present embodiment is different from that shown in FIG. 9 only on the point that coupling lens CL1 is positioned between the first semiconductor laser LD1 and the first dichroic prism DBS1, and coupling lens CL2 is positioned between the second semiconductor laser LD2 and the first dichroic prism DBS1. Even in the present embodiment, three semiconductor lasers LD1-LD3 and a light-receiving portion of photodetector (light-receiving element) PD are mutually in the optically conjugate relationship through information recording surfaces of optical discs of OD1-OD3.

In the present embodiment, light fluxes emitted from respective semiconductor lasers LD1 and LD2 are transformed by respective coupling lenses CL1 and CL2 into parallel light fluxes, thus, all of them enter coupling lens COL in the form of a parallel light flux. However, since the light flux emitted from the semiconductor laser LD3 enters the coupling lens COL in the form of a finite divergence light flux, it is possible to make it to correspond to a protective substrate thickness of CD of 1.2 mm. Further, the coupling lens COL can cause a light flux to emerge at a prescribed divergent angle and to enter the objective lens OBJ by moving the second group to the first-third positions in the optical axis direction depending on the optical disc to be used, thus, the spherical aberration can be restrained as stated above.

Incidentally, though semiconductor lasers LD1-LD3 and the light receiving portion of photodetector (light-receiving elements) PD need to be positioned to keep the optically conjugate relationship, this relationship sometimes fails to be kept due to errors in parts precisions and assembling precisions.

In this case, at least one coupling lens (for example, CL3) of coupling lenses CL1 and CL2 is made to be movable and positionaly adjusted along the optical axis, and by moving and positionaly adjusting in the optical axis direction in the course of assembling, it is possible to correct focus offset caused by errors in mechanical positions in the optical axis direction of the light source, and thereby to make the optically conjugate relationship to hold easily between a semiconductor laser and a light-receiving portion of photodetector (light-receiving element) PD.

Examples suitable for the aforesaid embodiment will be explained next. Table 3 shows lens data of the examples. Hereinafter (including lens data in the table), it is assumed that the exponent for 10 (for example, 2.5×10⁻³) is expressed by using E (for example, 2.5E-3).

TABLE 3
(EXAMPLE) Example 1 Lens data

| | | | |
|---|---|---|---|
| Magnification of total optical system | 7.71 | 7.49 | 6.74 |
| Coupling lens (divergent angle conversion element) | −1/2.4 | −1/3.0 | 1/3.8 |
| magnification | | | |
| Numerical aperture on image surface side | NA1: 0.67 | NA2: 0.65 | NA3: 0.51 |

| i^{th} | | di | ni | | di | ni | di | ni | Name of a |
|---|---|---|---|---|---|---|---|---|---|
| surface | ri | (407 nm) | (407 nm) | ri | (655 nm) | (655 nm) | (785 nm) | (785 nm) | part |
| 0 | | 0.5 | | | 0.5 | | 0.5 | | Light source |
| 1 | ∞ | 0.25 | 1.5299 | ∞ | 0.25 | 1.5144 | 0.25 | 1.5111 | *1 |
| 2 | ∞ | 1.506 | 1.0 | ∞ | 3.951 | 1.0 | 3.951 | 1.0 | |
| 3 | ∞ | 3 | 1.5299 | | | | | | Beam shaper |
| 4 | ∞ | 0.5 | 1.0 | | | | | | |
| 5 | ∞ | 0.5 | 1.5299 | ∞ | 0.5 | 1.5144 | 0.5 | 1.5111 | Wavelength |
| | | | | | | | | | plate |
| 6 | ∞ | 0.5 | 1.0 | ∞ | 0.5 | 1.0 | 0.5 | 1.0 | |
| 7 | ∞ | 1.6 | 1.5299 | | 1.6 | 1.5144 | 1.6 | 1.5111 | Beam splitter |
| 8 | ∞ | 3 | 1.0 | | 3 | 1.0 | 3 | 1.0 | |
| 9 | 106.95 | 0.8 | 1.5428 | | 0.8 | 1.5292 | 0.8 | 1.5254 | Coupling lens |
| 10 | 3.8744 | 1.8 | 1.0 | | 1.7093 | 1.0 | 0.3 | 1.0 | |
| 11 | 5.4311 | 1 | 1.5428 | | 1 | 1.5292 | 1 | 1.5254 | |
| 12 | −5.9992 | 4 | 1.0 | | 4.0907 | 1.0 | 5.5 | 1.0 | |
| 13 *3 | ∞ | 0.0 | 1.0 | | 0.0 | 1.0 | 0.0 | 1.0 | |
| | | (φ2.30 mm) | | | (φ2.30 mm) | | (φ1.95 mm) | | |
| 14 | 1.1268 | 1.00000 | 1.5428 | | 1.00000 | 1.5292 | 1.00000 | 1.5254 | Objective |
| | | | | | | | | | lens |
| 14′ | 1.1268 | 0.00000 | 1.5428 | | 0.00000 | 1.5292 | 0.00000 | 1.5254 | |
| 15 | −5.8696 | 0.759 | 1.0 | | 0.805 | | 0.587 | 1.0 | |
| 16 | ∞ | 0.6 | 1.6187 | | 0.6 | 1.5775 | 1.2 | 1.5706 | *2 |
| 17 | ∞ | | | | | | | | |

*The symbol di represents a displacement form i^{th} surface to (i + 1)^{th} surface
*The symbol di′ represents a displacement from i^{th} surface to i′^{th} surface, and di′′ represents a displacement from i^{th} surface to i′′^{th} surface,
*3: (Aperture diameter)
*No numerical value data is described for a beam shaper and a wavelength plate
*1: Protective substrate of light source,
*2: Optical information recording medium

Divergent Angle Conversion Element

9^{th} Surface
Aspheric surface coefficient
   κ −5.5906E+01
   A4 2.8997E-03
   A6 −1.1716E-03

10^{th} Surface
Aspheric surface coefficient
   κ −5.0110E+00
   A4 5.7774E-03
   A6 −1.3980E-03

11^{th} Surface
Aspheric surface coefficient
   κ −3.9979E+00
   A4 8.3928E-04
   A6 −7.2950E-05

12^{th} Surface.
Aspheric surface coefficient
   κ −4.1970E+00
   A4 1.3268E-03
   A6 4.2864E-05
      Objective Optical Element

14^{th} Surface (0 mm≦h≦0.967 mm)
Aspheric surface coefficient
   κ −3.5439E-01
   A4 9.3103E-04
   A6 −2.2020E-02
   A8 1.9563E-02
   A10 2.1640E-03
   A12 −9.0776E-03
   A14 8.9517E-04
   Optical path difference function (HD DVD: Diffraction
   order n=10, DVD: Diffraction order n=6, CD: Diffraction
   order n=5, Manufacture wavelength λB=407 nm)
   B2 −5.4634E-04
   B4 −5.2429E-05
   B6 −3.6016E-04
   B8 7.4264E-04
   B10 −3.9449E-04

14′^{th} Surface (0.987 mm≦h)
Aspheric surface coefficient
   κ −3.5439E-01
   A4 9.3103E-04
   A6 −2.2020E-02
   A8 1.9563E-02
   A10 2.1640E-03
   A12−9.0776E-03
   A14 8.9517E-04
   Optical path difference function
      (HD DVD: Diffraction order n=5, DVD: Diffraction order
   n=3, Manufacture wavelength λB=407 nm)
   B2 −1.0927E-03
   B4 −1.0486E-04
   B6 −7.2032E-04
   B8 1.4853E-03
   B10 −7.8897E-04
   15^{th} surface
   Aspheric surface coefficient
   κ −2.8046E+θ2
   A4 −4.6928E-02
   A6 1.5971E-01
   A8 −1.8631E-01
   A10 1.0705E-01
   A12 −2.6542E-02.
   A14 1.1769E-03

Incidentally, an optical surface of an objective optical system is formed to be an aspheric surface that is defined by a numerical expression wherein a coefficient shown in Table 3 is substituted in Numeral 2 expression, and is axially symmetric about an optical axis.
Z=(h²/r)/[1+√{1−(κ+1)(h/r)²}]+A₄h⁴+A₆⁶+A₈h⁸+A₁₀h¹⁰+A₁₂h¹²+A₁₄h¹⁴ (Numeral 1)

In the aforesaid expression, z represents an aspheric surface form (a distance in the direction along the optical axis from a plane that is tangent to the aspheric surface at the vertical point of the aspheric surface, h represents a distance from the optical axis, r represents a radius of curvature, K represents a conic constant and each of A₄, A₆, A₈, A₁₀, A₁₂, and A₁₄ represents an aspheric surface coefficient.

An optical path length given to a light flux with each wavelength by a diffractive structure is defined by a numerical expression wherein a coefficient shown in Table 3 is substituted in an optical path difference function of Numeral 3 expression.
φ=dor×λ/λ_{B}×(B₂h²+B₄h⁴+B₆h⁶+B₈h⁸+B₁₀h¹⁰) (Numeral 2)

In the aforesaid expression, φ represents an optical path difference function, λ represents a wavelength of a light flux entering a diffractive structure, λ_{B} represents a blaze wavelength (manufacture wavelength), dor represents a diffraction order of diffracted light used for recording and/or reproducing for an optical disc, h represents a distance from an optical axis each of B₂, B₄, B₆, B₈ and B₁₀ is an optical path difference function coefficient.

While the invention has been described with reference to a specific embodiment, the invention should not be construed to be limited to the aforesaid embodiment, and it will be apparent to those skilled in the art that many alternatives, modifications and variations may be made, without departing from the spirit and scope of the invention. Accordingly, the 2-laser 1-packaged laser device may also be a combination of the first semiconductor laser LD1 and the second semiconductor laser LD2. Further, plural drive unit may also be provided in place of a single driving unit.

What is claimed is:

1. An optical pickup apparatus comprising:
a first light source for emitting a light flux with a wavelength λ1;
a second light source for emitting a light flux with a wavelength λ2 (λ1<λ2);
a third light source for emitting a light flux with a wavelength λ3 (λ2<λ3);
an objective lens for converging a light flux from each of the first to third light sources on an information recording surface of a corresponding optical information recording medium;
a coupling lens arranged in a common optical path of the light fluxes emitted by the first to third light sources and in an optical path between the objective lens and each of the first to third light sources;
a light flux splitter for separating a light flux reflected by the information recording surface of the optical information recording medium from a light flux emitted from each of the first to third light sources; and
a light-receiving element for receiving a light flux reflected by the information recording surface of the optical information recording medium and separated by the light flux splitter,
wherein the coupling lens is formed of two or more lenses in two or more groups,
at least one group of the lenses forming the coupling lens is arranged movably along an optical axis of the coupling lens,
the light-receiving element comprises a light-receiving portion for receiving the light flux emitted from the first light sources, the light flux emitted from the second light sources, and the light flux emitted from the third light sources, and the light-receiving portion is packaged in one light-receiving element,
the coupling lens with the at least one group moved to a first position provides a first divergent angle (θ1) to the light flux emitted by the first light source, the light flux provided the first divergent angle by the coupling lens enters into the objective lens, and the objective lens converges the entering light flux on an information recording surface of a first information recording medium with a recording density ρ1 for information recording and/or reproducing,
the coupling lens with the at least one group moved to a second position provides a second divergent angle (θ2) to the light flux emitted by the second light source, the light flux provided the second divergent angle by the coupling lens enters into the objective lens, and the objective lens converges the entering light flux on an information recording surface of a second information recording medium with a recording density ρ2 (ρ1>ρ2) for information recording and/or reproducing,
the coupling lens with the at least one group moved to a third position provides a third divergent angle (θ3) to the light flux emitted by the third light source, the light flux provided the third divergent angle by the coupling lens enters into the objective lens, and the objective lens converges the entering light flux on an information recording surface of a third information recording medium with a recording density ρ3 (ρ2>ρ3) for information recording and/or reproducing,
the first light source and the light-receiving portion in the light-receiving element are optically conjugate each other through the information recording surface of the first information recording medium when the at least one group of the coupling lens is positioned at the first position,
the second light source and the light-receiving portion in the light-receiving element are optically conjugate each other through the information recording surface of the second information recording medium when the at least one group of the coupling lens is positioned at the second position, and
the third light source and the light-receiving portion in the light-receiving element are optically conjugate each other through the information recording surface of the third information recording medium when the at least one group of the coupling lens is positioned at the third position.

2. The optical pickup apparatus of claim 1,
wherein the wavelength λ1 is in a range of 390 to 420 nm,
the wavelength λ2 is in a range of 630 to 670 nm, and
the wavelength λ3 is in a range of 760 to 800 nm.

3. The optical pickup apparatus of claim 1,
wherein each of the light flux emitted by the first light source and reflected by the information recording surface of the first optical information recording medium,
the light flux emitted by the second light source and reflected by the information recording surface of the second optical information recording medium, and
the light flux emitted by the third light source and reflected by the information recording surface of the third optical information recording medium
passes through a common optical element and is received by the light-receiving portion of the light-receiving element.

4. The optical pickup apparatus of claim 1,
wherein at least two groups of the lenses in the coupling lens are arranged so that a distance of an air space between the at least two groups is variable along an optical axis.

5. The optical pickup apparatus of claim 1,
wherein one group of the lenses in the coupling lens is arranged movably along the optical axis and the other is arranged stably.

6. The optical pickup apparatus of claim 1,
wherein the first optical information recording medium is Blu-ray Disc or HD DVD,
the second optical information recording medium is DVD, and
the third optical information recording medium is CD.

7. The optical pickup apparatus of claim 1,
wherein the coupling lens is composed of two lenses individually having aspheric surfaces.

8. The optical pickup apparatus of claim 1,
wherein the light flux splitter is a polarizing beam splitter, and
a numerical aperture of the coupling lens at the light source side is 0.12 or less.

9. The optical pickup apparatus of claim 1,
wherein the optical pickup apparatus corrects a spherical aberration caused by a substrate thickness difference among the first to third optical information recording media by moving the at least one group of the lenses in the coupling lens along the optical axis.

10. The optical pickup apparatus of claim 1,
wherein at least two of the first to third light sources are fixed on a common heat sink.

11. The optical pickup apparatus of claim 1, further comprising:
a drive unit for driving the at least one group of the lenses in the coupling lens so as to be moved along the optical axis.

12. The optical pickup apparatus of claim 11,
wherein the drive unit comprises an electromechanical transducer;
the driving member fixed to one end of the electromechanical transducer; and
a movable member connected to the at lest one group of lenses in the coupling lens and movably supported on the driving member, and
the drive unit moves the movable member by repeatedly expanding and contracting at different speeds in extending direction and in contracting direction.

13. The optical pickup apparatus of claim 1, further comprises a lens positioned adjustably along the optical axis in an optical path between the coupling lens and at least one of the first light source, the second light source and the third light source, and in an optical path closer to the at least one of the light sources than the light flux splitter.
